(19) United States
(12) Patent Application Publication
(10) Pub. No.: US 2024/0166928 A1
(43) Pub. Date: May 23, 2024

(54) LAMINATING ADHESIVE

(71) Applicant: BOSTIK SA, COLOMBES (FR)

(72) Inventors: Francis PARDAL, Venette (FR); Marion JARNOUX, Venette (FR); Dimitri BAUGNON, Venette (FR); Ludwig FAROUX, Venette (FR)

(21) Appl. No.: 18/281,581

(22) PCT Filed: Mar. 18, 2022
(86) PCT No.: PCT/FR2022/050500

§ 371 Date: Sep. 12, 2023

(30) Foreign Application Priority Data
Mar. 18, 2021 (FR) FR2102702

(51) Int. Cl. C09J 175/06

(52) U.S. Cl. CPC C09J 175/06

(57) ABSTRACT

The present invention concerns a two-component adhesive composition comprising an —OH component and an —NCO component and characterized in that: —the —OH component is a composition comprising at least one polyol A1; 1-the —NCO component is a composition comprising at least one polyurethane P2 obtained by a process comprising the following steps: S1) preparing a polyurethane prepolymer P1 comprising at least two terminal —NCO functions by a polyaddition reaction: i) of at least one polyester polyol A2 having a number-average molecular mass (Mn) of from 8000 to 12 000 g/mol; ii) of at least one polyol A3 having a molar mass of not more than 200 g/mol, said polyol A3 comprising at least one secondary OH function; iii) of at least one polyisocyanate; iv) of an optional polyol A4; in amounts such that the molar ratio NCO/OH (r1) is from 1.7 to 2.2; and S2) reacting the product formed at the end of step S1) with at least one aminosilane, in amounts such that the molar ratio NCO/NH (r2) is from 10 to 25.

### FIELD OF THE INVENTION

The present invention relates to a solvent-based two-component polyurethane adhesive composition.

The invention also relates to a multilayer structure (or complex) which may be used notably in the field of flexible packaging, which comprises at least two layers of material bonded together by a layer of the crosslinked composition according to the invention.

The present invention also relates to the use of said multilayer structure for the preparation of flexible packaging for food products.

### TECHNOLOGICAL BACKGROUND

Flexible (or supple) packagings intended in particular for the packaging of agrifood products generally consist of several thin layers (in the form of sheets or films), the thickness of which is between 5 and 150 μm, which consist of different materials, such as paper, a metal (for example aluminum) or also by thermoplastic polymers. These thin layers are adhesively bonded together, and the corresponding complex (or multilayer) film, whose thickness may range from 20 to 400 μm, allows the properties of the various individual layers of material (also referred to as “supports”) to be combined, thus offering the consumer a set of characteristics suitable for the final flexible packaging, for instance its visual appearance (notably that of printed elements presenting information relating to the packaged product and intended for the consumer, or its transparency), a barrier effect against light or atmospheric moisture or gases, notably oxygen, or suitable thermal resistance.

The various layers of materials of which the multilayer film is composed are typically combined or assembled by laminating during industrial lamination processes. These processes use adhesives (or glues) and items of equipment (or machines) which are designed for this purpose and which operate continuously generally with very high line speeds, of the order of several hundred meters per minute. The multilayer film thus obtained is itself often referred to as a “laminate”.

These lamination processes first of all comprise a step of coating the adhesive over a first film of material, which consists of the deposition of a continuous layer of adhesive with a controlled thickness generally of less than 10 μm, corresponding to an amount of adhesive (or weight per unit area) generally not exceeding 10 g/m². This coating step is followed by a step of laminating a second film of material, which is identical to or different from the first, consisting of the application under pressure of this second film to the first film covered with the layer of adhesive.

The complex films are thus finally obtained in very large width format and are generally conditioned by winding, in the form of wide reels from 1 m to 1.50 m in diameter having, like the film which they store, a width of up to 2 m. These large reels may be stored and transported for use either directly by industrial agrifood manufacturers, for packaging their products, or by converters.

In both cases, the film is cut to reduce its width and is shaped to manufacture sachets, which are themselves intended for the packaging of a product, for example an agrifood product.

Solvent-based two-component polyurethane lamination adhesives are widely used as adhesive for the manufacture of multilayer systems intended for the field of flexible packaging. The use of said solvent-based adhesives in the lamination process necessitates a step of evaporation of the organic solvent. This step is performed before the laminating step by passing through an oven the first film covered with adhesive following the coating step.

The solvent-based two-component polyurethane lamination adhesives are supplied to the laminator in the form of two compositions (or components):
one (known as —NCO component) comprising chemical species bearing isocyanate —NCO end groups, and
the other (known as —OH component) comprising chemical species bearing hydroxyl —OH end groups.

The mixing of these two components may be performed at ambient temperature by the operator of the laminating machine prior to its start-up, which enables correct functioning thereof, by virtue of an appropriate viscosity.

On conclusion of the step of coating of the mixture thus obtained on the first thin layer and of the step of laminating of the second layer, the isocyanate groups of the —NCO component react with the hydroxyl groups of the —OH component, according to a reaction referred to as crosslinking, to form a polyurethane which is in the form of a three-dimensional network comprising urethane groups, providing the cohesion of the adhesive seal between the two thin laminated layers.

Flexible packaging professionals know that certain ingredients intended for packaging (in sachets, wipes or trays, for example) are highly aggressive and may damage the packaging (multilayer film). These ingredients may migrate through the various packaging layers and degrade the performance of the adhesive layer. For example, certain ingredients may migrate through the first film used for its sealability properties (low melting point). These sealable films, generally made of polyethylene or polypropylene, are highly permeable. After migration through this first film, the ingredient finds itself in direct contact with the adhesive layer. Several phenomena (swelling, accumulation of simulant between a substrate and the adhesive layer, adhesive degradation, etc.) may lead to a loss in adhesive performance, and also to a deterioration in the appearance of the laminate: the appearance of bubbles or delamination channels. Aggressive ingredients can be classified according to their chemical nature: acid (vinegar, ketchup, etc.), alkaline (detergent), fatty (oil, mayonnaise), spicy (hot pepper), etc. In the field of flexible lamination, there is a need for universal adhesives that are resistant to all types of ingredients. To date, however, the existing solutions only partially meet this need insofar as the adhesives are resistant to one type of ingredient in particular.

Moreover, adhesive compositions with good chemical resistance are known to contain starting materials that are toxic or that should soon be banned for regulatory reasons, despite their positive impact on adhesion performance. This is notably the case for epoxy resins and bisphenol-A.

Finally, polyurethane-based adhesive compositions generally have the drawback of using a predominantly NCO-terminated NCO component comprising high residual contents of diisocyanate monomers originating from the reaction for the synthesis of the NCO-terminated polyurethane prepolymer. These residual amounts of (“free”) diisocyanate monomers of low molecular mass are capable of migrating through the multilayer film, after the use of the two-component adhesive, and therefore through the final flexible packaging. Thus, said compounds are capable of forming by hydrolysis, on contact with the water or the moisture present in particular in packaged foods, primary aromatic amines (PAAs), which are regarded as being very harmful to human health and the environment.

There is thus a need for a novel adhesive composition which at least partially overcomes at least one of the abovementioned drawbacks.

More particularly, there is a need for novel adhesive compositions offering a good compromise between good chemical resistance to aggressive ingredients of various kinds, good adhesive properties, and a reduced content of residual monomers.

There is also a need for novel adhesive compositions with a viscosity that is stable over time.

### DESCRIPTION OF THE INVENTION

### Composition

The present invention relates to a solvent-based two-component adhesive composition, comprising an —OH component and an —NCO component, characterized in that:
the —OH component is a composition comprising at least one polyol A1;
the —NCO component is a composition comprising at least one polyurethane P2 obtained via a process comprising the following steps:
   E1) the preparation of a polyurethane prepolymer P1 comprising at least two —NCO end functions via a polyaddition reaction:
      i) of at least one polyester polyol A2 having a number-average molecular mass (Mn) ranging from 8000 to 12 000 g/mol;
      ii) of at least one polyol A3 having a molar mass of less than or equal to 200 g/mol, said polyol A3 comprising at least one secondary OH function;
      iii) of at least one polyisocyanate;
      iv) of an optional polyol A4;
      in amounts such that the NCO/OH mole ratio (r1) ranges from 1.7 to 2.2, preferably from 1.8 to 2.1;
and
   E2) the reaction of the product formed at the end of step E1) with at least one aminosilane, in amounts such that the NCO/NH mole ratio (r2) ranges from 10 to 25 and preferably from 15 to 21.
      —OH component

The —OH component is a composition comprising at least one polyol A1.

The polyol A1 may be chosen from:
diols with a molar mass of less than or equal to 200 g/mol, and
polyols with a number-average molecular mass of greater than 200 g/mol, chosen from polyester polyols, polyether polyols, polyene polyols, polycarbonate polyols, —OH-terminated polymers, and mixtures thereof.

The hydroxyl functionality of the polyol A1 may range from 2 to 6. Preferably, the hydroxyl functionality of the polyol A1 is 2. The hydroxyl functionality is the mean number of hydroxyl functions per mole of polyol.

The polyol A1 may be chosen from polyols with a number-average molecular mass of greater than 200 g/mol and less than or equal to 3000 g/mol, chosen from polyester polyols, polyether polyols, polyene polyols, polycarbonate polyols, —OH-terminated polymers, and mixtures thereof.

Polyester polyols A1 with a number-average molecular mass of greater than 200 g/mol may be chosen from polyester diols and polyester triols.

Among the polyester polyols, examples that may be mentioned include:
polyester polyols of natural origin, such as castor oil;
polyester polyols resulting from the polycondensation:
of one or more aliphatic (linear, branched or cyclic) or aromatic polyols, for instance monoethylene glycol, diethylene glycol, 1,2-propanediol, 1,3-propanediol, 1,4-butanediol, butenediol, 1,6-hexanediol, cyclohexanedimethanol, tricyclodecanedimethanol, neopentyl glycol, cyclohexanedimethanol, glycerol, trimethylolpropane, 1,2,6-hexanetriol, sucrose, glucose, sorbitol, pentaerythritol, mannitol, N-methyldiethanolamine, triethanolamine, a fatty alcohol dimer, a fatty alcohol trimer, and mixtures thereof, with
one or more polycarboxylic acids or an ester or anhydride derivative thereof, such as 1,6-hexanedioic acid (adipic acid), dodecanedioic acid, azelaic acid, sebacic acid, adipic acid, 1,18-octadecanedioic acid, phthalic acid, isophthalic acid, terephthalic acid, succinic acid, a fatty acid dimer, a fatty acid trimer, and mixtures of these acids, an unsaturated anhydride, for instance maleic or phthalic anhydride, or a lactone, for instance caprolactone;
estolide polyols resulting from the polycondensation of one or more hydroxy acids, such as ricinoleic acid, with a diol (examples that may be mentioned include Polycin® D-1000 and Polycin® D-2000 available from Vertellus).

The abovementioned polyester polyols can be prepared conventionally and are for the most part commercially available.

Among the polyester polyols with an Mn of greater than 200 g/mol, examples may be mentioned include the following products with a hydroxyl functionality equal to 2: Tone® 0240 (sold by Union Carbide), which is a polycaprolactone with a number-average molecular mass of about 2000 g/mol, and a melting point of about 50° C., or Dekatol® 3008 (sold by the company Bostik), with a number-average molar mass Mn of about 1060 g/mol, and a hydroxyl number ranging from 102 to 112 mg KOH/g. It is a product resulting from the condensation of adipic acid, diethylene glycol and monoethylene glycol.

The polyester polyols preferably have a number-average molecular mass ranging from 1000 to 2000 g/mol.

The polyether polyols with a number-average molecular mass of greater than 200 g/mol may be chosen from polyoxyalkylene polyols, the linear or branched alkylene portion of which comprises from 1 to 4 carbon atoms, more preferentially from 2 to 3 carbon atoms.

As examples of polyoxyalkylene diols or triols, examples that may be mentioned include:
polyoxypropylene diols or triols (also denoted as polypropylene glycol (PPG) diols or triols) having a number-average molecular mass (Mn) ranging from 300 to 12 000 g/mol;
polyoxyethylene diols or triols (also denoted as polyethylene glycol (PEG) diols or triols) having a number-average molecular mass (Mn) ranging from 300 to 12 000 g/mol;
and mixtures thereof.

The abovementioned polyether polyols may be prepared conventionally and are widely available commercially. They may be obtained by polymerization of the corresponding alkylene oxide in the presence of a basic catalyst (for example potassium hydroxide) or a catalyst based on a double metal/cyanide complex.

As examples of polyether diols, mention may be made of the polyoxypropylene diol sold under the name Voranol® P 400 by the company Dow, with a number-average molecular mass (Mn) in the region of 400 g/mol and the hydroxyl number of which ranges from 250 to 270 mg KOH/g. As examples of polyether triols, mention may be made of the polyoxypropylene triol sold under the name Voranol® CP 450 by the company Dow, with a number-average molecular mass (Mn) in the region of 450 g/mol and the hydroxyl number of which ranges from 370 to 396 mg KOH/g, or the polyoxypropylene triol sold under the name Voranol® CP3355 by the company Dow, with a number-average molecular mass in the region of 3554 g/mol.

The polyene polyols with a molecular mass of greater than 200 g/mol may be chosen from polyenes including hydroxyl end groups, and the corresponding hydrogenated or epoxidized derivatives thereof. The polyene polyols may be chosen from polybutadienes including hydroxyl end groups, which are optionally hydrogenated or epoxidized. Preferentially, the polyene polyol(s) that may be used according to the invention are chosen from butadiene homopolymers and copolymers including hydroxyl end groups, which are optionally hydrogenated or epoxidized.

In the context of the invention, and unless otherwise mentioned, the term “hydroxyl end groups” of a polyene polyol means the hydroxyl groups located at the ends of the main chain of the polyene polyol.

The abovementioned hydrogenated derivatives can be obtained by complete or partial hydrogenation of the double bonds of a polydiene comprising hydroxyl end groups, and are thus saturated or unsaturated.

The epoxidized derivatives mentioned above may be obtained by chemoselective epoxidation of the double bonds of the main chain of a polyene including hydroxyl end groups, and thus include at least one epoxy group in its main chain.

Examples of polyene polyols that may be mentioned include saturated or unsaturated butadiene homopolymers comprising hydroxyl end groups, which are optionally epoxidized, for instance those sold under the name Poly BD® or Krasol® by the company Cray Valley. The polycarbonate polyols may be chosen from polycarbonate diols or triols, in particular with a number-average molecular mass (Mₙ) ranging from 300 to 12 000 g/mol.

As example of a polycarbonate diol, mention may be made of Converge® Polyol 212-10 and Converge® Polyol 212-20 sold by the company Novomer, having respective number-average molecular masses (Mr) equal to 1000 and 2000 g/mol, the hydroxyl numbers of which are, respectively, 112 and 56 mg KOH/g.

The polymers bearing —OH end groups may be obtained by a polyaddition reaction between one or more polyols and one or more polyisocyanates, in amounts of polyisocyanate(s) and of polyol(s) leading to an NCO/OH mole ratio strictly less than 1. The reaction may be performed in the presence of a catalyst. The polyols and polyisocyanates that may be used may be those typically used for the preparation of polymers bearing —OH end groups, for instance those described in the present patent application.

According to a preferred embodiment, the polyol A1 is chosen from diols with a molar mass of less than or equal to 200 g/mol, preferentially less than or equal to 150 g/mol.

Among the diols with a molar mass of less than or equal to 200 g/mol, mention may be made of ethylene glycol, diethylene glycol, propylene glycol, dipropylene glycol, propane-1,3-diol, butane-1,4-diol, neopentyl glycol, 2-methyl-1,3-propanediol, hexane-1,6-diol or mixtures thereof.

Preferably, the polyol A1 is diethylene glycol.

The —OH component may comprise at least one additive chosen from the group consisting of plasticizers, catalysts, rheological additives, solvents, pigments, adhesion promoters (for instance aminosilanes), moisture absorbers, UV stabilizers (or antioxidants), dyes, fillers, and mixtures thereof. The total content of these optional additives may be up to 5% by weight, relative to the total weight of said —OH component.

The —OH component may comprise more than 80% by weight polyol(s) A1, preferably more than 90% by weight, preferentially more than 95% by weight, and even more preferentially more than 99% by weight polyol(s) A1 relative to the total weight of said OH component.

The —OH component may have a viscosity at 23° C. ranging from 1 to 3000 mPa·s.

The measurement of the viscosity at 23° C. may be performed using a Brookfield viscometer according to the standard ISO 2555 published in 1999. Typically, the measurement taken at 23° C. may be performed using a Brookfield RVT viscometer with a spindle suitable for the viscosity range and at a rotational speed of 20 revolutions per minute (rpm).

### —NCO Component

The —NCO component is a composition comprising at least one polyurethane P2 obtained via a process comprising the following steps:

E1) the preparation of a polyurethane prepolymer P1 comprising at least two —NCO end functions via a polyaddition reaction:
i) of at least one polyester polyol A2 having a number-average molecular mass (Mn) ranging from 8000 to 12 000 g/mol;
ii) of at least one polyol A3 having a molar mass of less than or equal to 200 g/mol, said polyol A3 comprising at least one secondary OH function;
iii) of at least one polyisocyanate;
iv) of an optional polyol A4;
in amounts such that the NCO/OH mole ratio (r1) ranges from 1.7 to 2.2, preferably from 1.8 to 2.1;
and
   E2) the reaction of the product formed at the end of step E1) with at least one aminosilane, in amounts such that the NCO/NH mole ratio (r2) ranges from 10 to 25 and preferably from 15 to 21.

Polyester Polyol A2

The polyester polyol A2 has a number-average molecular mass Mn of greater than 8500 g/mol, preferably greater than or equal to 9000 g/mol and even more preferentially greater than or equal to 10 000 g/mol.

The polyester polyol A2 is preferably a copolyester obtained via a polycondensation reaction:
of at least one aliphatic diol (i); with
at least one aromatic diacid (ii) chosen from terephthalic acid, isophthalic acid, phthalic acid and a diester or anhydride derivative thereof; and
at least one aliphatic diacid (iii) or a diester or anhydride derivative thereof.

The number-average molecular mass Mn is measured by size exclusion chromatography (or SEC), which is also denoted by the term gel permeation chromatography (or GPC). The calibration performed is usually a PEG (PolyEthylene Glycol) or PS (PolyStyrene), preferably PS, calibration.

The hydroxyl number (denoted NOH) of the polyester polyol A2, and more generally of a polyol, (denoted NOH), represents the number of hydroxyl functions per gram of polyol and is expressed in the form of the equivalent number of milligrams of potassium hydroxide (KOH) used in the assaying of the hydroxyl functions, determined by titrimetry, according to the standard ISO 14900:2017. The NOH is related to the number-average molecular mass Mn by the relationship:

NOH=(56.1×2×1000)/Mn

The aliphatic diol (i) may be linear or branched and is chosen from the group consisting of ethylene glycol (CAS: 107-21-1), diethylene glycol, triethylene glycol, tetraethylene glycol, 1,2-propanediol, dipropylene glycol, tripropylene glycol, tetrapropylene glycol, 1,6-hexanediol, 3-ethyl-2-methyl-1,5-pentanediol, 2-ethyl-3-propyl-1,5-pentanediol, 2,4-dimethyl-3-ethyl-1,5-pentanediol, 2-ethyl-4-methyl-3-propyl-1,5-pentanediol, 2,3-diethyl-4-methyl-1,5-pentanediol, 3-ethyl-2,2,4-trimethyl-1,5-pentanediol, 2,2-dimethyl-4-ethyl-3-propyl-1,5-pentanediol, 2-methyl-2-propyl-1,5-pentanediol, 2,4-dimethyl-3-ethyl-2-propyl-1,5-pentanediol, 2,3-dipropyl-4-ethyl-2-methyl-1,5-pentanediol, 2-butyl-2-ethyl-1,5-pentanediol, 2-butyl-2,3-diethyl-4-methyl-1,5-pentanediol, 2-butyl-2,4-diethyl-3-propyl-1,5-pentanediol, 3-butyl-2-propyl-1,5-pentanediol, 2-methyl-1,5-pentanediol (CAS: 42856-62-2), 3-methyl-1,5-pentanediol (MPD, CAS: 4457-71-0), 2,2-dimethyl-1,3-pentanediol (CAS: 2157-31-5), 2,2-dimethyl-1,5-pentanediol (CAS: 3121-82-2), 3,3-dimethyl-1,5-pentanediol (CAS: 53120-74-4), 2,3-dimethyl-1,5-pentanediol (CAS: 81554-20-3), 2,2-dimethyl-1,3-propanediol (neopentyl glycol-NPG, CAS: 126-30-7), 2,2-diethyl-1,3-propanediol (CAS: 115-76-4), 2-methyl-2-propyl-1,3-propanediol (CAS: 78-26-2), 2-butyl-2-ethyl-1,3-propanediol (CAS: 115-84-4), 2-methyl-1,3-propanediol (CAS: 2163-42-0), 2-benzyloxy-1,3-propanediol (CAS: 14690-00-7), 2,2-dibenzyl-1,3-propanediol (CAS: 31952-16-6), 2,2-dibutyl-1,3-propanediol (CAS: 24765-57-9), 2,2-diisobutyl-1,3-propanediol, 2,4-diethyl-1,5-pentanediol, 2-ethyl-1,6-hexanediol (CAS: 15208-19-2), 2,5-dimethyl-1,6-hexanediol (CAS: 49623-11-2), 5-methyl-2-(1-methylethyl)-1,3-hexanediol (CAS: 80220-07-1), 1,4-dimethyl-1,4-butanediol, 1,5-hexanediol (CAS: 928-40-5), 3-methyl-1,6-hexanediol (CAS: 4089-71-8), 3-(tert-butyl)-1,6-hexanediol (CAS: 82111-97-5), 1,3-heptanediol (CAS: 23433-04-7), 1,2-octanediol (CAS: 1117-86-8), 1,3-octanediol (CAS: 23433-05-8), 2,2,7,7-tetramethyl-1,8-octanediol (CAS: 27143-31-3), 2-methyl-1,8-octanediol (CAS: 109359-36-6), 2,6-dimethyl-1,8-octanediol (CAS: 75656-41-6), 1,7-octanediol (CAS: 3207-95-2), 4,4,5,5-tetramethyl-3,6-dioxa-1,8-octanediol (CAS: 76779-60-7), 2,2,8,8-tetramethyl-1,9-nonanediol (CAS: 85018-58-2), 1,2-nonanediol (CAS: 42789-13-9), 2,8-dimethyl-1,9-nonanediol (CAS: 40326-00-9), 1,5-nonanediol (CAS: 13686-96-9), 2,9-dimethyl-2,9-dipropyl-1,10-decanediol (CAS: 85018-64-0), 2,9-dibutyl-2,9-dimethyl-1,10-decanediol (CAS: 85018-65-1), 2,9-dimethyl-2,9-dipropyl-1,10-decanediol (CAS: 85018-64-0), 2,9-diethyl-2,9-dimethyl-1,10-decanediol (CAS: 85018-63-9), 2,2,9,9-tetramethyl-1,10-decanediol (CAS: 35449-36-6), 2-nonyl-1,10-decanediol (CAS: 48074-20-0), 1,9-decanediol (CAS: 128705-94-2), 2,2,6,6,10,10-hexamethyl-4,8-dioxa-1,11-undecanediol (CAS: 112548-49-9), 1-phenyl-1,11-undecanediol (CAS: 109217-58-5), 2-octyl-1,11-undecanediol (CAS: 48074-21-1), 2,10-diethyl-2,10-dimethyl-1,11-undecanediol (CAS: 85018-66-2), 2,2,10,10-tetramethyl-1,11-undecanediol (CAS: 35449-37-7), 1-phenyl-1,11-undecanediol (CAS: 109217-58-5), 1,2-undecanediol (CAS: 13006-29-6), 1,2-dodecanediol (CAS: 1119-87-5), 2,11-dodecanediol (CAS: 33666-71-6), 2,11-diethyl-2,11-dimethyl-1,12-dodecanediol (CAS: 85018-68-4), 2,11-dimethyl-2,11-dipropyl-1,12-dodecanediol (CAS: 85018-69-5), 2,11-dibutyl-2,11-dimethyl-1,12-dodecanediol (CAS: 85018-70-8), 2,2,11,11-tetramethyl-1,12-dodecanediol (CAS: 5658-47-9), 1,11-dodecanediol (CAS: 80158-99-2), 11-methyl-1,7-dodecanediol (CAS: 62870-49-9), 1,4-dodecanediol (CAS: 38146-95-1), 1,3-dodecanediol (CAS: 39516-24-0), 1,10-dodecanediol (CAS: 39516-27-3), 2,11-dimethyl-2,11-dodecanediol (CAS: 22092-59-7), 1,5-dodecanediol (CAS: 20999-41-1), 6,7-dodecanediol (CAS: 91635-53-9), and cyclohexanedimethanol.

Preferably, the diol (i) is chosen from ethylene glycol, diethylene glycol, trimethylene glycol, hexamethylene glycol, propylene glycol (or propane-1,2-diol), propane-1,3-diol, (1,4-, 1,3- or 1,2-)butanediol, neopentyl glycol, 2-methyl-1,3-propanediol, hexanediol or cyclohexanedimethanol.

According to a preferred variant, the diol (i) is chosen from ethylene glycol and diethylene glycol.

Even more preferably, two diols (i) consisting, respectively, of ethylene glycol and diethylene glycol are used.

Among the diester derivatives of terephthalic acid, isophthalic acid or of phthalic acid that may be used as monomers (ii), examples that may be mentioned include dimethyl terephthalate or dimethyl isophthalate. As example of an anhydride derivative of an aromatic diacid for the monomer (ii), mention may be made of phthalic anhydride.

Preferably, two diacids (ii) consisting, respectively, of terephthalic acid and isophthalic acid are used.

The aliphatic diacid (iii) may be linear or branched and is chosen, for example, from adipic acid, azelaic acid, sebacic acid, cyclohexanedicarboxylic acid, dodecanedicarboxylic acid, 1,10-decanedicarboxylic acid and succinic acid.

Preferably, adipic acid is used as aliphatic diacid (iii).

According to a preferred embodiment, the polyester polyol A2 is an amorphous polyester polyol.

For the purposes of the invention, and unless otherwise stated, the term “amorphous polyester polyol” means a polyester polyol which is shown not to have a melting point when analyzed by Differential Scanning calorimetry (DSC).

According to a preferred embodiment, the polyester polyol A2 is obtained by polycondensation:
of two aliphatic diols (i) consisting, respectively, of ethylene glycol and diethylene glycol; with
two diacids (ii) consisting, respectively, of terephthalic acid and isophthalic acid; and
adipic acid as aliphatic diacid (iii).

When some among the monomers (ii) and optionally (iii) are diester derivatives, for instance methyl or ethyl diester derivatives, said monomers are, in a first step, mixed with one or more diol monomers (i), said mixture being brought to a temperature that may range up to 190° C., so as to perform a transesterification reaction, preferably in the presence of a titanium-based or zinc-based catalyst, and to eliminate the methanol or ethanol formed. In a second step, the monomers (ii) and optionally (iii) which are diacids are added, as a mixture with one or more diol monomers (i), the reaction medium being brought to a temperature that may range up to 230° C., so as to perform the esterification reaction and to eliminate the water formed. Finally, in a third step, the pressure is lowered to a value of less than about 5 mbar and the reaction medium is brought to a higher temperature, up to a value in the region of 250° C., so as to increase the length of the chains of the polyester polyol to achieve a given NOH value.

The polyester polyol A2 may be in dry form or in solvated form. The solvent may be chosen, for example, from the group consisting of esters, ketones and aromatic compounds, and mixtures thereof. The solvent may be chosen, for example, from ethyl acetate, butyl acetate, methyl ethyl ketone, methyl isobutyl ketone, toluene, xylene and mixtures thereof.

Polyol A3

The number-average molar mass Mn of the polyol A3 may be less than or equal to 150 g/mol.

The hydroxyl functionality of the polyol A3 may range from 2 to 6. Preferably, the hydroxyl functionality of the polyol A3 is 2. The hydroxyl functionality is the mean number of hydroxyl functions per mole of polyol.

The polyol A3 may be chosen from the group consisting of 1,2-propanediol or monopropylene glycol (CAS: 57-55-6), dipropylene glycol (CAS: 25265-71-8), tripropylene glycol (CAS: 24800-44-0), 2,2-dimethyl-1,3-pentanediol (CAS: 2157-31-5), 5-methyl-2-(1-methylethyl)-1,3-hexanediol (CAS: 80220-07-1), 1,4-dimethyl-1,4-butanediol, 1,3-heptanediol (CAS: 23433-04-7), 1,2-octanediol (CAS: 1117-86-8), 1,3-octanediol (CAS: 23433-05-8), 1,7-octanediol (CAS: 3207-95-2), 1,2-nonanediol (CAS: 42789-13-9), 1,5-nonanediol (CAS: 13686-969), 1,9-decanediol (CAS: 128705-94-2), 1,2-undecanediol (CAS: 13006-29-6), and mixtures thereof.

The polyol A3 is preferably chosen from monopropylene glycol, dipropylene glycol and mixtures thereof.

Optional Polyol A4

The polyurethane prepolymer P1 obtained in step E1) may be prepared in the presence of a polyol A4 different from the abovementioned polyols A2 and A3.

The hydroxyl functionality of the polyol A4 is preferably 3. The hydroxyl functionality is the mean number of hydroxyl functions per mole of polyol.

The polyol A4 may be chosen from glycerol, trifunctional polyether polyols (triols), trimethylolalkanes comprising an alkane comprising from 1 to 20 carbon atoms and 3 methylol groups.

Among the trifunctional polyether polyols, examples that may be mentioned include polyoxyalkylene triols, in which the linear or branched alkylene portion contains from 1 to 4 carbon atoms, more preferentially from 2 to 3 carbon atoms. They may be, for example, polyoxypropylene triols (also denoted as polypropylene glycol (PPG) triols) having a number-average molecular mass (Mn) ranging from 300 to 12 000 g/mol, or polyoxyethylene triols (also denoted as polyethylene glycol (PEG) triols) having a number-average molecular mass (Mn) ranging from 300 to 12 000 g/mol.

The trifunctional polyether polyols may be prepared conventionally and are widely available commercially. They may be obtained by polymerization of the corresponding alkylene oxide in the presence of a basic catalyst (for example potassium hydroxide) or a catalyst based on a double metal/cyanide complex.

As examples of polyether triols, mention may be made of the polyoxypropylene triol sold under the name Voranol® CP 450 by the company Dow with a number-average molecular mass (Mn) in the region of 450 g/mol and the hydroxyl number of which ranges from 370 to 396 mg KOH/g, or the polyoxypropylene triol sold under the name Voranol® CP3355 by the company Dow with a number-average molecular mass in the region of 3554 g/mol, or Acclaim® 6300, which is a trifunctional PPG with a number-average molecular mass of about 5948 g/mol and with a hydroxyl number NOH equal to 28.3 mg KOH/g.

Among the trimethylolalkanes comprising an alkane comprising from 1 to 20 carbon atoms and 3 methylol groups, examples that may be mentioned include trimethylolmethane, trimethylolethane, trimethylolpropane, trimethylol(n-butane), trimethylolisobutane, trimethylol(s-butane), trimethylol(t-butane), trimethylolpentane, trimethylolhexane, trimethylolheptane, trimethyloloctane, trimethylolnonane, trimethyloldecane, trimethylolundecane and trimethyloldodecane.

Preferably, the polyol A4 is chosen from trimethanolalkanes comprising an alkane containing from 1 to 20 carbon atoms and 3 methylol groups, and even more preferentially is trimethylolpropane.

Polyisocyanate

The polyisocyanate may be chosen from diisocyanates, triisocyanates, and mixtures thereof;

Among the diisocyanates, examples that may be mentioned include the group consisting of isophorone diisocyanate (IPDI), pentamethylene diisocyanate (PDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), (2,5)-bis(isocyanatomethyl)bicyclo[2.2.1]heptane (2,5-NBDI), (2,6)-bis(isocyanatomethyl)bicyclo[2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI) (in particular m-xylylene diisocyanate (m-XDI)), toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), tetramethylxylylene diisocyanate (TMXDI) (in particular tetramethyl(meta)xylylene diisocyanate), a PDI allophanate (n=5) or HDI allophanate (n=6) having, for example, the formula (Y) below:

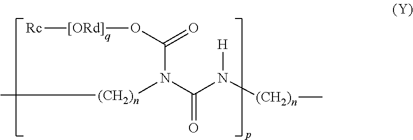

in which p is an integer ranging from 1 to 2, q is an integer ranging from 0 to 9 and preferably 2 to 5, R_{c} represents a saturated or unsaturated, cyclic or acyclic, linear or branched hydrocarbon-based chain comprising from 1 to 20 carbon atoms, preferably from 6 to 14 carbon atoms, R_{d} represents a linear or branched divalent alkylene group containing from 2 to 4 carbon atoms, and preferably a divalent propylene group;
and mixtures thereof.

The diisocyanates are preferably aromatic diisocyanates, arylaliphatic diisocyanates or cycloaliphatic diisocyanates.

Preferably, the diisocyanates are chosen from toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), isophorone diisocyanate (IPDI), xylylene diisocyanate (XDI) (in particular m-xylylene diisocyanate (m-XDI)) and HDI or PDI allophanates.

Among the triisocyanates, examples that may be mentioned include isocyanurates, biurets and adducts of diisocyanates and of triols.

The isocyanurates may be used in the form of a technical mixture of (poly)isocyanurate(s) with a purity of greater than or equal to 70% by weight of isocyanurate(s).

Examples of diisocyanate trimers that may be mentioned include:
the isocyanurate trimer of hexamethylene diisocyanate (HDI):

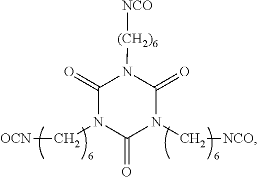

the isocyanurate trimer of isophorone diisocyanate (IPDI):

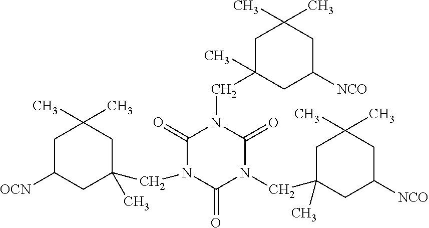

As examples of adducts of diisocyanates and of triols that may be used according to the invention, mention may be made of the adduct of meta-xylylene diisocyanate and of trimethylolpropane, as represented below. This adduct is sold, for example, by the company Mitsui Chemicals, Inc. under the name Takenate® D-110N.

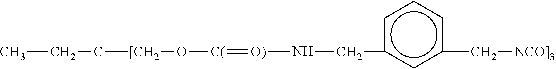

The polyisocyanates are widely available commercially. By way of example, mention may be made of Scuranate® TX sold by the company Vencorex, corresponding to a 2,4-TDI with a purity of about 95%, Scuranate® T100 sold by the company Vencorex, corresponding to a 2,4-TDI with a purity of greater than 99% by weight, and Desmodur® I sold by the company Covestro, corresponding to an IPDI.

According to a preferred embodiment, the polyisocyanate is a diisocyanate, and even more preferentially is diphenylmethane diisocyanate.

The diphenylmethane diisocyanate may comprise at least 90% by weight of the 4,4′ isomer, on the basis of the total weight thereof, and preferably at least 95%.

Mention may be made, for example, of Isonate® M125 from the company Dow, the 4,4′ isomer content of which is at least 97% by weight, and the 2,2′ isomer content of which is less than 0.1%. The percentage of —NCO groups of this product (expressed on a weight/weight basis) is equal to 33.6%.

Step E1— Synthesis of the Polyurethane P1

During step E1), the polyaddition reaction may be performed at a temperature below 95° C., for example between 50° C. and 80° C.

In the context of the invention, and unless otherwise mentioned, (r1) is the NCO/OH mole ratio corresponding to the mole ratio of the number of isocyanate groups (NCO) to the number of hydroxyl groups (OH) borne by all of the polyisocyanate(s) and polyol(s) present in the reaction medium of step E1).

The polyaddition reaction of step E1) may be performed in the presence or absence of at least one reaction catalyst.

The catalyst can be any catalyst known to those skilled in the art for catalyzing the formation of polyurethane by reaction of at least one polyisocyanate with at least one polyol.

An amount ranging up to 0.3% by weight of catalyst(s), relative to the weight of the reaction medium of step E1), may be used.

The reaction of step E1) may also be performed in the presence of a solvent. The solvent may be chosen from the group consisting of esters, ketones and aromatic compounds, and mixtures thereof. The solvent may be added during step E1) or may come from the starting reagents dissolved in said solvent. The solvent may be chosen, for example, from the group consisting of esters, ketones and aromatic compounds, and mixtures thereof. The solvent may be chosen, for example, from ethyl acetate, butyl acetate, methyl ethyl ketone, methyl isobutyl ketone, toluene, xylene and mixtures thereof.

The polyurethane P1 may have a mass content of NCO groups ranging from 0.5% to 5% by weight, preferably from 1% to 3% by weight, relative to the total weight of the polyurethane P1.

The set of conditions described above for obtaining the polyurethane prepolymer P1 advantageously make it possible to obtain a concentration of unreacted diisocyanate monomer(s) which is low enough at the end of the reaction for the polyurethane prepolymer P1 to be able to be used directly after its synthesis in the preparation of the —NCO component, without it being necessary to treat it, for example by purification, distillation or selective extraction processes as employed in the prior art, in order to remove or reduce the excess of unreacted diisocyanate monomer(s) present in the reaction product.

The —NCO component obtained may thus comprise a content of diisocyanate monomer(s) of less than or equal to 3.5% by weight (preferably less than or equal to 3.0% by weight), relative to the weight of the —NCO component (dry extract).

Step E2— Synthesis of the Polyurethane P2

Step E2) may be performed at a temperature of less than 95° C., for example between 40° C. and 80° C.

In the context of the invention, and unless otherwise mentioned, (r2) is the NCO/NH mole ratio corresponding to the mole ratio of the number of isocyanate groups NCO to the number of NH functions borne, respectively, by all of the isocyanates (as notably regards the polyurethane bearing NCO end groups and optionally the polyisocyanate(s) which have not reacted at the end of step E1)), and aminosilanes present in the reaction medium of step E2).

The polyaddition reaction of step E2) may be performed in the presence or absence of at least one reaction catalyst.

The catalyst may be any catalyst known to a person skilled in the art. An amount ranging up to 0.3% by weight of catalyst(s), relative to the weight of the reaction medium of step E2), may be used.

The reaction of step E2) may also be performed in the presence of a solvent. The solvent may be chosen from the group consisting of esters, ketones and aromatic compounds, and mixtures thereof. The solvent may be added during step E1), during step E2) or may come from the starting reagents dissolved in said solvent. The solvent may be chosen, for example, from ethyl acetate, butyl acetate, methyl ethyl ketone, methyl isobutyl ketone, toluene, xylene and mixtures thereof.

Aminosilane

The aminosilanes notably contain an amine function as a function that is reactive with the —NCO function of the polyurethane prepolymer P1 obtained on conclusion of step E1).

The aminosilane preferably has the following formula (I):

R⁴O)₃₋ₚ(R³)ₚ Si—R¹—NH—R² (I)

in which:
R³, which may be identical or different, each represents a linear or branched monovalent hydrocarbon-based radical comprising from 1 to 10 carbon atoms;
R⁴, which may be identical or different, represents a linear or branched monovalent hydrocarbon-based radical comprising from 1 to 10 carbon atoms;
or two R⁴ groups may form a ring;
p is an integer equal to 0, 1 or 2, preferably equal to 0 or 1 and even more preferentially equal to 0;
R¹ represents a linear or branched divalent alkylene radical comprising from 1 to 12 carbon atoms, preferably from 1 to 6 carbon atoms, R³ preferentially representing methylene or n-propylene, and
R² represents H, a linear or branched alkyl radical, an arylalkyl radical, a cyclic radical comprising from 1 to 20 carbon atoms, or a radical having the following formula (II):

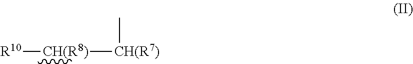

in which:
   R⁷ and R⁸ are, independently of each other, hydrogen or a radical chosen from the group consisting of —R⁹, —COOR⁹ and —CN;
   the radical R¹⁰ is hydrogen, or a radical chosen from the group consisting of —CH₂—COOR⁹, —COOR⁹, —CONHR⁹, —CON(R⁹)₂, —CN;
   the radical R⁹ being a hydrocarbon-based radical containing from 1 to 20 carbon atoms optionally comprising at least one heteroatom.

In particular, the radical of formula (II) may be chosen from one of the following radicals:

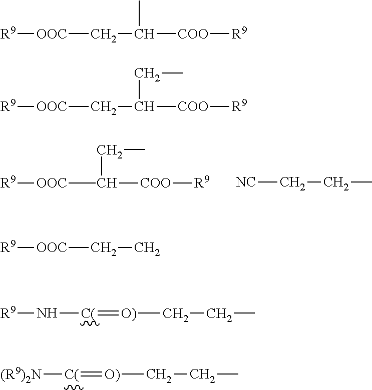

in which R⁹ is as defined previously.

According to a preferred embodiment, the aminosilane of formula (I) is that in which:
R³, which may be identical or different, each represents a linear or branched alkyl group comprising from 1 to 10 carbon atoms, preferably from 1 to 5 carbon atoms;
R⁴, which may be identical or different, each represents a linear or branched alkyl group comprising from 1 to 10 carbon atoms, preferably from 1 to 5 carbon atoms,
p is an integer equal to 0, 1 or 2, preferably p is 0;
R¹ represents a linear or branched divalent alkylene radical comprising from 1 to 12 carbon atoms, preferably from 1 to 6 carbon atoms, R¹ preferentially representing n-propylene, and
R² represents H.

The aminosilanes of formula (I) above are preferably primary aminosilanes, for instance 3-aminopropyltrimethoxysilane, 3-aminopropyltriethoxysilane, 3-aminopropyldiethoxymethylsilane, 3-aminopropyldimethoxymethylsilane; secondary aminosilanes, for instance N-butyl-3-aminopropyltrimethoxysilane, N-butyl-3-aminopropyltriethoxysilane, N-phenyl-3-aminopropyltrimethoxysilane, N-phenyl-3-aminopropyltriethoxysilane; the reaction products of the Michael addition of primary aminosilanes, for instance 3-aminopropyltrimethoxysilane or 3-aminopropyldimethoxymethylsilane with Michael acceptors, for instance acrylonitrile, acrylic esters, acrylamides, maleic diesters, methylene malonate diesters, itaconic diesters.

Preferably, the aminosilane is 3-aminopropyltriethoxysilane.

The aminosilanes may be commercially available, for instance Dynasylan® 1189 sold by Evonik, or Silquest® A1100 sold by Momentive.

Polyurethane P2

The —NCO component may comprise from 20% to 100% by weight, preferably from 30% to 90% by weight, more preferentially from 40% to 80% by weight of polyurethane(s) P2 (dry extract) relative to the total weight of said —NCO component.

The polyurethane P2 may be a single polymer or a polymer blend.

The polyurethane P2 may have a mass content of NCO groups ranging from 0.5% to 5% by weight, preferably from 0.8% to 3% by weight, relative to the total weight of the polyurethane P2.

The polyurethane P2 may comprise at least one isocyanate group and at least one silylated group derived from the aminosilane. These groups may be located at the ends of the main chain and/or as side groups along the main chain.

Preferably, the polyurethane P2 comprises silyl groups derived from the aminosilane at one or both ends of the main chain, but not as side groups (silyl group functionality of less than or equal to 2).

The —NCO component (dry extract) may have a viscosity at 23° C. ranging from 2000 mPa·s to 8000 mPa·s.

NCO Component

The —NCO component may comprise at least one additive chosen from the group consisting of plasticizers, catalysts, rheological agents, solvents, pigments, adhesion promoters, moisture absorbers, UV stabilizers (or antioxidants), dyes, fillers, and mixtures thereof.

The —NCO component may comprise phosphoric acid, for example in a content ranging from 0.001% to 1% by weight relative to the total weight of said —NCO component. Phosphoric acid may be added during step E1, after step E1, during step E2 or after step E2.

The —NCO component may comprise at least one solvent, preferably in an amount ranging from 10% to 60% by weight, more preferentially ranging from 15% to 50% by weight and even more preferentially from 20% to 45% by weight, relative to the total weight of the —NCO component.

The solvent may be chosen from organic solvents and alcoholic solvents such as ethyl acetate, methyl ethyl ketone, xylene, ethanol, isopropanol, tetrahydrofuran, methyltetrahydrofuran or else from Isane® (based on isoparaffins, available from the company Total) or Exxol® D80 (based on aliphatic hydrocarbons, available from the company ExxonMobil Chemical).

Preferably, the —NCO component comprises ethyl acetate.

The —NCO component may also comprise a polyisocyanate comprising three NCO end groups, preferably an adduct of diisocyanate and triol. The content thereof may be less than or equal to 10% by weight relative to the total weight of said —NCO component.

Preferably, the —NCO component does not comprise any XDI-based triisocyanate, and more particularly the —NCO component does not comprise any triisocyanate.

According to a preferred embodiment, the —NCO component comprises:
from 30% to 90% by weight, more preferentially from 40% to 80% by weight, of polyurethane(s) P2) (dry extract);
from 10% to 60% by weight, more preferentially from 15% to 50% by weight and even more preferentially from 20% to 45% by weight of solvent(s);
from 0% to 1%, preferably from 0.001% to 1%, by weight of phosphoric acid;
the percentages being weight percentages relative to the total weight of said —NCO component.

Composition

The amounts of the —NCO and —OH components in said composition may be such that the —NCO/—OH equivalent mole ratio is within a range from 1.7 to 3, preferably from 1.9 to 2.5 and even more preferentially from 2 to 2.2.

The term “—NCO/—OH equivalent mole ratio” means the ratio of the equivalent number of —NCO groups (present in the —NCO component) to the equivalent number of —OH groups (present in the —OH component).

The mixing of the —NCO and —OH components, in the ratio indicated, may be performed at 23° C. by the operator of the laminating machine, before it is started up. The viscosity of the adhesive composition thus obtained can be adjusted by simple addition of solvent, resulting in a final amount of dry extract of the adhesive composition which may range in practice from 30% to 40% weight/weight. The adhesive composition thus obtained may be entirely suitable for use in a laminating machine and for correct operation of the latter.

### Uses

A subject of the present invention is also a multilayer (complex) structure comprising at least two layers of material bonded together by an adhesive layer, characterized in that said adhesive layer consists of the composition according to the invention in the crosslinked state.

The adhesive layer preferably has a thickness ranging from 1.2 to 5 μm.

The adhesive layer may be obtained by crosslinking the composition according to the invention in an amount preferably ranging from 0.5 to 5 g/m².

The materials of which the layers of material surrounding the adhesive layer are made are generally chosen from paper, metal, for instance aluminum, or thermoplastic polymers such as:
polyethylene (PE),
polypropylene (PP),
a copolymer based on ethylene and propylene,
polyamide (PA),
polyethylene terephthalate (PET), or else
a copolymer based on ethylene, for instance a maleic anhydride-grafted copolymer, a copolymer of ethylene and of vinyl acetate (EVA), a copolymer of ethylene and of vinyl alcohol (EVOH), a copolymer of ethylene and of an alkyl acrylate such as methyl acrylate (EMA) or butyl acetate (EBA),
polystyrene (PS),
polyvinyl chloride (PVC),
polyvinylidene fluoride (PVDF),
a polymer or copolymer of lactic acid (PLA), or
a polyhydroxyalkanoate (PHA).

An individual layer of material may itself consist of several materials. It may be, for example, a layer of thermoplastic polymers obtained by coextrusion of two polymers (there is then no adhesive between the coextruded layers), the individual layers of thermoplastic polymer may also be coated with a substance (for example based on aluminum oxide or silicon oxide) or metallized (in the case of PET metallized with aluminum particles) to add an additional barrier effect.

The thickness of the two layers of material adjacent to the adhesive layer and of the other layers of material used in the multilayer structure according to the invention may vary within a wide range extending, for example, from 5 to 150 μm. The total thickness of said structure may also be liable to vary within a wide range extending, for example, from 20 to 400 μm.

Preferably, the multilayer structure is in the form of a multilayer film.

According to a preferred variant, the film comprises from two to four thin layers of materials, said film then being respectively denoted two-layer, three-layer or four-layer.

According to one embodiment, said film is a three-layer film: PET/ALU/PE (bioriented polyester).

A subject of the invention is also a process for manufacturing the multilayer (complex) structure according to the invention, comprising the following steps:
mixing the —OH and —NCO components and, where applicable, diluting with an organic solvent to form an adhesive mixture, and then
coating said adhesive mixture over the surface of a first layer of material, and then
evaporating off the organic solvent;
laminating the surface of a second layer onto the surface coated with the first layer of material, and then
crosslinking said adhesive mixture.

The step of mixing the —OH and —NCO components may be performed at room temperature (23° C.) or with heating, before coating.

Preferably, the mixing is performed at a temperature below the decomposition temperature of the ingredients included in one or other of the —OH and —NCO components. In particular, the mixing is performed at a temperature below 95° C., preferably ranging from 15 to 80° C., more preferably ranging from 25° C. to 50° C., in order to avoid any thermal decomposition.

Said mixture may be coated onto all or part of the surface of a material. In particular, said mixture may be coated in the form of a layer with a thickness ranging from 1.5 to 5 μm. The coating is preferably performed continuously or substantially continuously.

Optionally, the crosslinking of said mixture on the surface of the material can be accelerated by heating the coated material(s) to a temperature of less than or equal to 70° C. The time required to complete this crosslinking reaction and to thus ensure the required level of cohesion is generally of the order of 0.5 to 24 hours.

The coating and laminating of the second material are generally performed within a time interval that is compatible with the coating process, as is well known to a person skilled in the art, that is to say before the adhesive layer loses its ability to attach the two materials by adhesive bonding.

Optionally, the crosslinking of said mixture on the surface of the material can be accelerated by heating the coated material(s) to a temperature of less than or equal to 70° C. The time required to complete this crosslinking reaction and thus to ensure the required level of cohesion is generally of the order of 0.5 to 24 hours.

The invention also relates to the use of the multilayer (complex) structure according to the invention for the manufacture of flexible packagings. Specifically, the complexes according to the invention may be used for the manufacture of very varied flexible packagings, which are formed and then closed (after the step of packaging the product intended for the consumer) via heat-sealing (or heat-welding) techniques.

In particular, the complex according to the invention may be used in food packaging, without any risk of toxicity. The packagings intended for foodstuffs may be heat-treated at temperatures ranging from 90° C. to 135° C. before use.

The multilayer structure is advantageously suitable for manufacturing flexible wrappings intended for packaging food products.

The adhesive composition according to the invention advantageously leads, after crosslinking, to a multilayer structure with good chemical resistance for different types of ingredients to be packaged.

It also advantageously has a reduced residual monomer content, allowing the formation of aromatic amines (PAA) to be drastically reduced.

The adhesive composition according to the invention advantageously leads to a good compromise between: good chemical resistance of the multilayer structure to many aggressive ingredients (after crosslinking), low toxicity, and good adhesive properties.

All the embodiments described above may be combined with each other. In particular, the various abovementioned constituents of the composition, and notably the preferred embodiments of the composition, may be combined with each other.

In the context of the invention, the term “between x and y” or “ranging from x to y” means a range in which the limits x and y are included. For example, the range “between 0% and 25%” notably includes the values 0% and 25%.

The invention is now described in the following implementation examples, which are given purely by way of illustration and should not be interpreted in order to limit the scope thereof.

### EXAMPLES

The following compounds were used in the examples:
Trimethylolpropane (TMP) (CAS 77-99-6) available from Perstorp (molar mass=134 g/mol);
Monopropylene glycol (CAS 57-55-6) available from BASF (molar mass=76 g/mol);
Isonate® M125 available from Dow: mixture of MDI isomers containing at least 97% of the 4,4′ isomer. Its functionality is equal to 2 and its NCO percentage 33.6%;
Desmodur® L75 available from Covestro: TDI/TMP adduct of toluene diisocyanate and trimethylolpropane containing 75% solids in ethyl acetate. Its NCO percentage is 13.3%;
Silquest® A1100, sold by the company Momentive and corresponding to a γ-aminopropyltriethoxysilane with a molar mass equal to 179.29 g/mol;
Phosphoric acid available from Prayon;
Diethylene glycol available from Sabic

### Example 1: Preparation of the Polyester Polyol A2

35.120 g of monoethylene glycol and 154.435 g of diethylene glycol are placed in a closed 1 liter reactor which is equipped with a stirrer, a distillation column, heating means and a thermometer and which is connected to a vacuum pump.

When the temperature of the reaction mixture reaches 120° C., the following are introduced into the reactor: 76.190 g of adipic acid, 170.035 g of isophthalic acid, 64.165 g of terephthalic acid and 0.035 g of a catalyst based on a titanium chelate (Tyzor® LA from the company DuPont). Next, a temperature gradient is programmed so as to reach a temperature of 230° C. in 3 h. The acid number (Nₐ) is then measured. The reaction is stopped when the acid number Nₐ is less than 25 mg KOH/g. 0.020 g of a titanium-based catalyst (of formula (nBuO)₄Ti, Tyzor® TnBT from the company DuPont) is then introduced, and the reactor is then placed under vacuum (15 mbar reached in 2 h) and the reaction mixture is heated to 240° C.

Measurements are taken of the Nₐ and of the Brookfield viscosity at 180° C. The reaction is stopped when the Nₐ is less than 3 mg KOH/g and when the viscosity is between 8000 and 9000 mPa·s.

The polyester polyol obtained is subsequently cooled to 200° C. and is then poured slowly into ethyl acetate at room temperature with stirring, to form a 59.47% weight/weight solution. The N O H of the polyester polyol thus obtained was measured according to the standard ISO 14900:2017 and is equal to 10 mg KOH/g, corresponding to an Mn of 11 220 g/mol.

### Example 2: —NCO Component (2A, 2B, 2C)

The polyisocyanate (except Desmodur® L75) and polyols are mixed in a reactor maintained under nitrogen and with constant stirring, at a temperature ranging from 75° C. to 77° C., in the amounts shown in Table 1. The whole is kept stirring at this temperature until the hydroxyl functions of the polyols have been completely consumed. The reaction progress is monitored by measuring the content of NCO groups by back titration of dibutylamine using hydrochloric acid, according to the standard NF T52-132. When the measured NCO group content is approximately equal to the desired NCO group content, phosphoric acid is added to the reaction mixture (at a temperature below 70° C.), which is then stirred for 30 minutes to homogenize the reaction medium. Silquest® A1100 is then added (at a temperature below 70° C.). The reaction mixture is stirred for 30 minutes, followed by addition of Desmodur® L75. Desmodur® 75 acts as a diluent and is not involved in any chemical reaction. After homogenizing the mixture (30 minutes) at 60-70° C., the Brookfield viscosity at 23° C. and the solids content are measured.

### Example 3: —NCO Component (3A)

The diisocyanate(s) and the polyols are mixed in a reactor maintained under nitrogen and with constant stirring, at a temperature ranging from 75° C. to 77° C., in the amounts shown in Table 1. The whole is kept stirring at this temperature until the hydroxyl functions of the polyols have been completely consumed. The reaction progress is monitored by measuring the content of NCO groups by back titration of dibutylamine using hydrochloric acid, according to the standard NF T52-132. When the measured NCO group content is approximately equal to the desired NCO group content, phosphoric acid is added to the reaction mixture (at a temperature below 70° C.), which is then stirred for 30 minutes to homogenize the reaction medium. Silquest® A1100 is then added (at a temperature below 70° C.).

TABLE 1
Compositions of the —NCO components

| | | Weight content in % | | | |
|---|---|---|---|---|---|
| | | Example | Example | Example | Example |
| | Ingredients | 2A | 3A | 2B | 2C |
| | Polyester polyol A2 | 78.786 | 80.240 | 75.110 | 74.560 |
| | synthesized in Example 1 | | | | |
| | Monopropylene glycol | 0.690 | 1.030 | 1.170 | 0.950 |
| | Trimethylolpropane | — | 0.250 | — | 0.230 |
| | Isonate ® M125 | 6.910 | 9.980 | 9.310 | 9.290 |
| | Desmodur ® L75 | 4.730 | — | 5.200 | 4.940 |
| | Phosphoric acid | 0.004 | 0.0050 | 0.005 | 0.005 |
| | Silquest ® A1100 | 0.370 | 0.400 | 0.400 | 0.380 |
| | Ethyl acetate | 8.510 | 8.095 | 8.805 | 9.645 |
| | total | 100% | 100% | 100% | 100% |
| | NCO/OH mole ratio (r1) | 2.02 | 1.90 | 1.88 | 1.91 |
| | NCO/NH mole ratio (r2) | 16.59 | 20.88 | 19.29 | 20.39 |
| —NCO | Brookfield viscosity at 23° C. | 4910 | 3580 | 3930 | 2950 |
| component | (mPa · s) | | | | |
| | Weight content of —NCO (in %) | 1.67 | 1.44 | 2.01 | 2.01 |

### Example 4: Two-Component Adhesive Compositions

An —OH component is mixed with the —NCO component of Example 2 (2A, 2B or 2C) or Example 3 (3A) with solvent to fluidize the adhesive mixture, then introduced between the laminating metering rollers at room temperature (23° C.) in a given weight ratio allowing a given NCO/OH mole ratio to be achieved.

The data for the two-component adhesive composition are given in Table 2.

TABLE 2
Two-component adhesive compositions

| | Ex. 4 | Ex. 5 | Ex. 6 | Ex. 7 |
|---|---|---|---|---|
| —OH component | Diethylene | Diethylene | Diethylene | Diethylene |
| | glycol | glycol | glycol | glycol |
| —NCO component | Ex. 2A | Ex. 3A | Ex. 2B | Ex. 2C |
| Solvent | Ethyl | Ethyl | Ethyl | Ethyl |
| | acetate | acetate | acetate | acetate |
| —NCO/—OH | 2.53 | 2.55 | 2.03 | 2.29 |
| equivalent | | | | |
| mole ratio | | | | |
| —NCO/—OH | 120/1 | 140/1 | 80/1 | 90/1 |
| component | | | | |
| weight ratio | | | | |

### Example 8: PET/ALU/PE Three-Layer Film

A three-layer film is prepared, consisting of a first PET film, a second aluminum film and a third PE film.

A 50 μm-thick PolyEthylene Terephthalate (PET) film, a 12 μm-thick aluminum (ALU) film and a 15 μm-thick bioriented polyester (PE) film are used. The tests are deliberately performed on a structure including a barrier layer (aluminum).

This three-layer film is obtained according to a sequential process by feeding the tank of a laminating machine of Nordmeccanica type with the two-component adhesive composition, for each of Examples 1/2 to 1/6.

Said laminating machine is provided with a coating device of roller type with an open tank, operating at ambient temperature and at a running speed of 50 m/minute. The adhesive layer bonding the three films at each PET/ALU and ALU/PE interface has a thickness of approximately 2 μm.

This three-layer film is subjected to the following tests:

A. 180° Peel Test The cohesion of the three-layer film is evaluated by a 180° peel test.

The 180° peel test is as described in the French standard NF T 54-122. The principle of this test consists in determining the force required to separate (or peel) two individual layers of films, which layers are bonded by the two-component adhesive (OH component/NCO component).

After it has been manufactured, the three-layer film is stored at room temperature (23° C.) and under an atmosphere having 50% relative humidity (RH). A sample is taken and subjected to the 180° peel test.

A test specimen of rectangular shape, with a width of 15 mm and a length of approximately 10 cm, is cut out of the three-layer film. Two individual layers (between PET/ALU and PE) of film comprised in this strip are manually detached from the end of this test specimen, and over approximately 2 cm, and the two free ends thus obtained are attached to two fastening devices respectively connected to a stationary part and a movable part of a tensile testing device which are located on a vertical axis.

While a drive mechanism imparts a uniform speed of 100 mm/minute to the movable part, resulting in the detachment of the two layers, the detached ends of which gradually move along a vertical axis with the formation of an angle of 180°, the stationary part—connected to a dynamometer—measures the force which is withstood by the test specimen thus held and which is expressed in N/15 mm.

B. Method for Evaluating the Chemical Resistance

Sachets are made from the PET/ALU/PE three-layer complex shown in Example 8 (cutting template 12.2×10.2 cm; surface area in contact with simulant 240 cm²). The sachets are filled with 20 g of simulant (orange juice is introduced at 85° C., other simulants are introduced at 23° C.). The sachets are placed in a climatic chamber maintained at a temperature of 40° C. for 25 days.

The peel forces are measured before and after aging (kinetic monitoring).

The peel force after aging must not be less than 40% of the initial value.

The results are given in Table 3 below:

TABLE 3
results

| PET/ALU/PE three-layer film | 8A | 8B | 8C | 8D |
|---|---|---|---|---|
| Adhesive used in the three-layer film | Ex. 4 | Ex. 5 | Ex. 6 | Ex. 7 |
| Peel force at the ALU/PE interface | 10.2 | 10.4 | 10.7 | 10.7 |
| (N/15 mm) | | | | |
| Peel force at the ALU/PE interface | 8.0 | 7.5 | 8.5 | 9.5 |
| (N/15 mm) after 25 days at 40° C. | | | | |
| Simulant: Isopropanol + distilled | | | | |
| water (50/50 mass ratio) | | | | |
| Peel force at the ALU/PE interface | 9.2 | 8.8 | 9.0 | 10.3 |
| (N/15 mm) after 25 days at 40° C. | | | | |
| Simulant: orange juice | | | | |
| Peel force at the ALU/PE interface | 5.0 | 6.0 | 8.0 | 9.3 |
| (N/15 mm) after 25 days at 40° C. | | | | |
| Simulant: Ketchup (Heinz) | | | | |

The peel values obtained between aluminum and polyethylene are higher than 4N/15 mm, and are entirely satisfactory in view of the aggressiveness of the various simulants tested (alcohol, acid, high-temperature introduction).

1-20. (canceled)

21. A solvent-based two-component adhesive composition, comprising an —OH component and an —NCO component, characterized in that:
the —OH component is a composition comprising at least one polyol A1;
the —NCO component is a composition comprising at least one polyurethane P2 obtained via a process comprising the following steps:
E1) the preparation of a polyurethane prepolymer P1 comprising at least two —NCO end functions via a polyaddition reaction:
i. of at least one polyester polyol A2 having a number-average molecular mass (Mn) ranging from 8000 to 12,000 g/mol;
ii. of at least one polyol A3 having a molar mass of less than or equal to 200 g/mol, said polyol A3 comprising at least one secondary OH function;
iii. of at least one polyisocyanate;
iv. of an optional polyol A4;
in amounts such that the NCO/OH mole ratio (r1) ranges from 1.7 to 2.2; and
E2) the reaction of the product formed at the end of step E1) with at least one aminosilane, in amounts such that the NCO/NH mole ratio (r2) ranges from 10 to 25.

22. The composition as claimed in claim 21, characterized in that the polyol A1 is chosen from:
diols with a molar mass of less than or equal to 200 g/mol, and
polyols with a number-average molecular mass of greater than 200 g/mol, wherein the polyols are selected from the group consisting of polyester polyols, polyether polyols, polyene polyols, polycarbonate polyols, —OH-terminated polymers, and mixtures thereof.

23. The composition as claimed in claim 21, characterized in that the polyol A1 comprises ethylene glycol, diethylene glycol, propylene glycol, dipropylene glycol, propane-1,3-diol, butane-1,4-diol, neopentyl glycol, 2-methyl-1,3-propanediol, hexane-1,6-diol or mixtures thereof.

24. The composition as claimed in claim 21, characterized in that the polyester polyol A2 has a number-average molar mass Mn greater than or equal to 8500 g/mol.

25. The composition as claimed in claim 21, characterized in that the polyester polyol A2 is a copolyester obtained by polycondensation reaction:
of at least one aliphatic diol (i); with
at least one aromatic diacid (ii) chosen from terephthalic acid, isophthalic acid, phthalic acid and a diester or anhydride derivative thereof; and
at least one aliphatic diacid (iii) or a diester or anhydride derivative thereof.

26. The composition as claimed in claim 21, characterized in that the polyester polyol A2 is an amorphous polyester polyol.

27. The composition as claimed in claim 21, characterized in that the polyol A3 is selected from the group consisting of monopropylene glycol, dipropylene glycol and mixtures thereof.

28. The composition as claimed in claim 21, characterized in that the polyol A4 is selected from the group consisting of glycerol, trifunctional polyether polyols (triols), trimethylolalkanes comprising an alkane comprising from 1 to 20 carbon atoms and 3 methylol groups.

29. The composition as claimed in claim 21, characterized in that the polyol A4 is selected from the group consisting of trimethylolmethane, trimethylolethane, trimethylolpropane, trimethylol(n-butane), trimethylolisobutane, trimethylol(s-butane), trimethylol(t-butane), trimethylolpentane, trimethylolhexane, trimethylolheptane, trimethyloloctane, trimethylolnonane, trimethyloldecane, trimethylolundecane and trimethyloldodecane.

30. The composition as claimed in claim 21, characterized in that the polyisocyanate is selected from the group consisting of diisocyanates, triisocyanates and mixtures thereof.

31. The composition as claimed in claim 21, characterized in that the polyurethane P1 has a mass content of NCO groups ranging from 0.5% to 5% by weight, relative to the total weight of the polyurethane P1.

32. The composition as claimed in claim 21, characterized in that the aminosilane has the formula (I) below:
(R⁴O)₃₋ₚ(R³)pSi-R¹—NH—R² (I)
in which:
R³, which may be identical or different, each represents a linear or branched monovalent hydrocarbon-based radical comprising from 1 to 10 carbon atoms;
R⁴, which may be identical or different, represents a linear or branched monovalent hydrocarbon-based radical comprising from 1 to 10 carbon atoms; or two R⁴ groups can form a ring;
p is an integer equal to 0, 1 or 2;
R¹ represents a linear or branched divalent alkylene radical comprising from 1 to 12 carbon atoms, and
R² represents H, a linear or branched alkyl radical, an arylalkyl radical, a cyclic radical comprising from 1 to 20 carbon atoms, or a radical having the following formula (II): 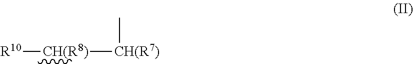
in which:
R⁷ and R⁸ are, independently of each other, hydrogen or a radical chosen from the group consisting of —R⁹, —COOR⁹ and —CN;
the radical R¹⁰ is hydrogen, or a radical chosen from the group consisting of —CH₂—COOR⁹, —COOR⁹, —CONHR⁹, —CON(R⁹)₂, and —CN;
the radical R⁹ being a hydrocarbon-based radical containing from 1 to 20 carbon atoms optionally comprising at least one heteroatom.

33. The composition as claimed in claim 21, characterized in that step E1) is performed in the presence of an acid, for instance phosphoric acid.

34. The composition as claimed in claim 21, characterized in that the —NCO component comprises from 20% to 100% by weight, of polyurethane(s) P2 (dry extract), relative to the total weight of said —NCO component.

35. The composition as claimed in claim 21, characterized in that the —NCO component does not comprise any XDI-based triisocyanate.

36. The composition as claimed in claim 21, characterized in that the —NCO component and/or the —OH component comprises at least one additive chosen from the group consisting of plasticizers, catalysts, solvents, pigments, adhesion promoters, moisture absorbers, UV stabilizers (or antioxidants), dyes, fillers, and mixtures thereof.

37. The composition as claimed in claim 21, characterized in that the amounts of the —NCO and —OH components in said composition are such that the —NCO/—OH equivalent mole ratio is within a range from 1.7 to 3.

38. A multilayer structure comprising at least two layers of material bonded together by an adhesive layer, characterized in that said adhesive layer consists of the composition as claimed in claim 21, in the crosslinked state.

39. A process for manufacturing the multilayer structure as claimed in claim 38, comprising the following steps:
mixing the —OH and —NCO components and, where applicable, diluting with an organic solvent to form an adhesive mixture, and then
coating said adhesive mixture over the surface of a first layer of material, and then
evaporating off the organic solvent; and then
laminating the surface of a second layer onto the surface coated with the first layer of material, and then
crosslinking said adhesive mixture.

40. Flexible packagings comprising the multilayer film of claim 38.
